(19) United States
(12) Patent Application Publication
(10) Pub. No.: US 2022/0030533 A1
(43) Pub. Date: Jan. 27, 2022

(54) Devices and Methods for Handling Precise Timing Protocol Signaling from a Time Sensitive Network

(71) Applicant: Telefonaktiebolaget LM Ericsson (publ), Stockholm (SE)

(72) Inventors: Hubertus Andreas Munz, Aachen (DE); Torsten Dudda, Wassenberg (DE); Paul Schliwa-Bertling, Ljungsbro (SE); Kun Wang, Solna (SE); Stefano Ruffini, Rome (IT); John Walter Diachina, Garner, NC (US); Zhenhua Zou, Solna (SE)

(21) Appl. No.: 17/295,058

(22) PCT Filed: Oct. 16, 2019
(86) PCT No.: PCT/SE2019/051018

§ 371 Date: May 19, 2021

Related U.S. Application Data
(60) Provisional application No. 62/771,304, filed on Nov. 26, 2018.

(51) Int. Cl. H04W 56/00

(52) U.S. Cl. CPC H04W 56/0015; H04W 56/005

(57) ABSTRACT

A method, performed by a transmitting device in a wireless communication system, for handling generalized Precise Timing Protocol, gPTP, signaling, from a Time Sensitive Network, TSN is provided. The transmitting device receives (1101) a gPTP message from a TSN network. The gPTP message comprises time information and a time domain related to the time information. The transmitting device extracts (1102) the time information and the time domain from the gPTP message. The transmitting device transmits (1104) a 3GPP message to a receiving device. The 3GPP message comprises the time information and the time domain related to the time information.

### TECHNICAL FIELD

Embodiments herein relate to devices and methods for handling Precise Timing Protocol (PTP) signaling from a Time Sensitive Network (TSN) in a communications network. In particular, the embodiments herein refer to a transmitting device and a receiving device and methods therein for handling generalized PTP signaling in a 3GPP communications network, such as e.g. a Fifth Generation (5G) network.

### BACKGROUND

In a typical wireless communication network, wireless devices, also known as wireless communication devices, mobile stations, stations (STA) and/or User Equipment (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE or gNBs in 5G, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

### Time Sensitive Networking

Time Sensitive Networking (TSN) is based on the IEEE 802.3 Ethernet standard. TSN provides deterministic services through IEEE 802.3 networks, such as e.g. time synchronization, guaranteed low latency transmissions and high reliability to make legacy Ethernet, designed for best-effort communication, deterministic. The TSN features available today may be grouped into the following categories:
Time Synchronization (e.g. IEEE 802.1AS)
Bounded Low Latency (e.g. IEEE 802.1Qav, IEEE 802.1Qbu, IEEE 802.1Qbv, IEEE 802.1Qch, IEEE 802.1Qcr)
Ultra-Reliability (e.g. IEEE 802.1CB, IEEE 802.1Qca, IEEE 802.1Qci)
Network Configuration and Management (e.g. IEEE 802.1Qat, IEEE 802.1Qcc, IEEE 802.1Qcp, IEEE 802.1CS)

The configuration and management of the TSN network may be implemented in different manners, either in a centralized or in a distributed setup as defined in IEEE 802.1Qcc. The different configuration models are shown in FIGS. 1, 2 and 3. FIG. 1 shows a distributed TSN configuration model, FIG. 2 shows a centralized TSN configuration model, and FIG. 3 shows a fully centralized TSN Configuration Model, as defined in IEEE P802.1Qcc/D2.3.

The communication endpoints inside the TSN are referred to as Talker and Listener. A TSN network comprises multiple entities and features. All switches, which are referred to as bridges in the FIGS. 1 to 3, in between the Talker and the Listener need to support certain TSN features, like e.g. IEEE 802.1AS time synchronization. A TSN domain enables synchronized communication among nodes. The communication between Talker and Listener is performed in streams. A stream is based on certain requirements in terms of data rate and latency given by an application implemented at the Talker and/or the Listener. The TSN configuration and management features are used to setup the stream and guarantee the stream's requirements across the network. In the distributed model shown in FIG. 1, the Talker and Listener may for example use a Stream Reservation Protocol (SRP) to setup and configure a TSN stream in every switch along the path from Talker to Listener in the TSN network. Nevertheless, some TSN features require a central management entity referred to as Centralized Network Configuration (CNC) tool as shown in FIG. 2. The CNC may for example use Netconf and YANG models to configure the switches in the network for each TSN stream. This also allows the use of time-gated queueing as defined in IEEE 802.1Qbv that enables data transport in a TSN network with deterministic latency. With time-gated queueing on each switch, queues are opened or closed following a precise schedule that allows high priority packets to pass through the switch with minimum latency and jitter if it arrives at ingress port within the time the gate is scheduled to be open. In the fully centralized model, as shown in FIG. 3, a Centralized User Configuration (CUC) entity is further added that is used as a point of contact for Listener and Talker. The CUC collects stream requirements and endpoint capabilities from the devices and communicates with the CNC directly. The details about TSN configuration is explained in further detail in IEEE 802.1Qcc.

### TSN Stream Setup in the Centralized Configuration Model

FIG. 4 shows a sequence chart of the procedure of TSN stream configuration using the fully centralized configuration model as shown in FIG. 3. The steps performed to setup a TSN stream in the TSN network in fully centralized configuration mode are the following:

1. The CUC may receive input from e.g. an industrial application/engineering tool, such as e.g. a Programmable Logic Controller (PLC), which specifies the devices which are supposed to exchange time-sensitive streams.

2. The CUC reads the capabilities of end stations and applications in the TSN network that includes information about period/interval of user traffic and payload sizes.

3. Based on this above information the CUC selects Talker and Listener for each stream and creates other stream related info, such as:
A StreamID as an identifier for each TSN stream,
A StreamRank, and
UsertoNetwork Requirements.

4. The CNC discovers a physical network topology using for example a Link Layer Discovery Protocol (LLDP) and any network management protocol such as e.g. Remote Management Protocol (RMP).

5. The CNC reads TSN capabilities of the bridges (e.g. IEEE 802.1Q, 802.1AS, 802.1CB) in the TSN network, e.g. by means of a network management protocol.

6. The CUC initiates join requests to configure the streams in order to configure network resources at the bridges for a TSN stream from one Talker to one Listener.

7. Talker and Listener groups (a group of elements specifying a TSN stream) are created by CUC, as specified in IEEE 802.1Qcc, 46.2.2.

8. The CNC configures the TSN network such as the TSN domain.

9. The CNC checks the physical topology and checks if the time sensitive streams are supported by the bridges in the network.

10. The CNC performs scheduling and path computation of the streams.

11. The CNC configures TSN features in the bridges along the path in the TSN network.

12. The CNC returns a status (success or failure) of resulting resource assignment for streams to the CUC.

13. The CUC further configures end stations to start the user plane traffic exchange as defined initially between the Listener and the Talker.

In a TSN network, a stream identity (streamID) may be used to uniquely identify stream configurations. It is used to assign TSN resources to a user's stream. The streamID comprises two tuples, namely:
1. A MacAddress associated with the TSN Talker
2. A UniqueID to distinguish between multiple streams within end stations identified by MacAddress

In the distributed configuration model as illustrated in FIG. 1, there is no CUC and no CNC. The Talker is therefore responsible for initiation of a TSN stream. As no CNC is present, the bridges are configuring themselves which does not allow the use of for example time-gated queuing as defined in 802.1Qbv.

In the centralized model as depicted in FIG. 2 the Talker is responsible for stream initialization but the bridges are configured by CNC.

### 5G and TSN Interworking Basics

To connect devices wirelessly to a TSN network, 5G is a promising solution. The 5G standard also addresses factory use cases through a lot of new features, especially on the RAN to make it more reliable and reduce the transmit latency compared to 4G. The 5G network comprises three main components, which are the UE, the RAN instantiated as the gNB and nodes, such as a User Plane Function (UPF) within the 5G core network (5GCN). The 5G network architecture is illustrated in FIG. 5. A control plane of the 5G network further comprises a Network Repository Function (NRF), an Access Management Function (AMF), a Session Management Function (SMF), a Network Exposure Function (NEF), a Policy Control Function (PCF) and a Unified Data Management (UDF).

An ongoing research challenge is the inter-working of 5G and TSN as illustrated in FIG. 6. Both technologies define their own methods for network management and configuration and different mechanisms to achieve communication determinism that must somehow be arranged to enable end-to-end deterministic networking for industrial networks. In the following the device connected to the 5G network is referred to as 5G endpoint. A device connected to the TSN domain is referred to as a TSN endpoint.

Despite what is shown in FIG. 6 it is also possible that the UE is not connected to a single endpoint but instead to a TSN network comprising of at least one TSN bridge and at least one endpoint. The UE is in such a situation part of a TSN-5G gateway, in which end stations communicate with UEs within the context of a local TSN network that is isolated from the primary TSN network by the 5G network.

In the following, an example of how Ethernet transport in a 5G system (5GS) according to the scenario shown in FIG. 6 may work shall be described.

### Ethernet Protocol Data Units (PDUs) Relayed Over 5G Network

This scenario assumes cases where a single UE needs to support one or multiple endpoints, each having a distinct Ethernet MAC layer address. In other words, the UE may support multiple Ethernet ports.
The User Plane Function (UPF) that interfaces with the TSN switch is assumed to support the reception and transmission of Ethernet PDUs.
Upon receiving an Ethernet PDU from the TSN switch, the UPF must be able to associate the destination MAC address or addresses to, for example, a PDU session, e.g. based on the IP address of the UE associated with the destination MAC address, and then relay the Ethernet PDU to the appropriate node in the 5G network.
The gNB sends the Ethernet PDU to the UE using a data radio bearer (DRB) with reliability and latency attributes appropriate for supporting the Ethernet PDU transmission.
The UE recovers the Ethernet PDU, e.g. from the PDCP layer, and sends the Ethernet PDU to the endpoint associated with the destination MAC address, since the UE may support one or more Ethernet connected endpoints.
In summary, the original Ethernet PDU received by the UPF from the TSN switch is delivered transparently through the 5G network.
For the uplink direction the 5G network is expected to determine when a Radio Network Temporary Identifier (RNTI) is associated with the Ethernet operation, thereby allowing uplink payload, such as e.g. an Ethernet PDU, associated with the RNTI to be routed to a UPF. The UPF then simply sends the received Ethernet PDU to a TSN switch.

### Time Synchronization in TSN Networks

Many TSN features are based on precise time synchronization between all peers. Also, a lot of industrial applications rely on a precise synchronization. As introduced above this is achieved using e.g. IEEE 802.1AS or IEEE P802.1AS-rev. Within the TSN network it is therefore possible to achieve a synchronization with sub-microsecond error. In order to achieve this level of accuracy a hardware support may be required; e.g. for timestamping of packets.

In the network, a grandmaster (GM) is a node that transmits timing information to all other nodes in a master-slave architecture. The GM may be elected out of several potential nodes, by certain criteria that make the selected grandmaster superior.

In a TSN-extension of 802.1AS (i.e. P802.1AS-rev), it has been defined that next to a main GM also a second redundant backup GM may be configured. In case the main GM fails for any reason, devices in the TSN domain may be synched to the second redundant GM. The redundant GM may work in a hot-standby configuration.

In TSN based on IEEE P802.1AS-rev, which is also referred to as generalized Precise Timing Protocol (gPTP) there may be multiple time domains and associated gPTP domains supported in a TSN network. The gPTP supports two timescales:
Timescale PTP: The epoch is the PTP epoch (details in IEEE 802.1 AS-rev section 8.2.2) and this timescale is continuous. The unit of measure of the time is the SI second as realized on the rotating period.
Timescale ARB (arbitrary): The epoch for this timescale is domain startup time and can be setup by administrative procedure (more details in IEEE 802.1AS-rev, section 3.2).

Devices in the TSN network may be synched to multiple time domains. A local arbitrary time domain may also be referred to as a working clock.

One of the initial steps for setting up the TSN stream, as explained above, and shown in FIG. 4, is the establishment of a TSN domain by the CNC, by grouping endpoints, such as talkers and listeners, that are supposed to exchange time-sensitive streams. This list is provided by the CUC to the CNC. The CNC further configures the bridges connecting these endpoints such that each TSN domain, such as talkers, listeners and bridges, has its own working clock. Technically this can be done according to IEEE P802.1AS-rev, by configuring external port role configuration, mechanism.

FIG. 7 shows a PTP header used for every PTP packet (note, interpretation of some fields is being revised in the new edition of the IEEE1588 and correspondingly in the IEEE P802.1ASRev). The domain number (domainNumber) defines for each frame, which time domain the frame belongs to. PTP time domains allow using multiple independent PTP clocks on a single network infrastructure. These numbers need to be configured at each end-station—so that each end-station is aware about which time domain it requires.

The PTP header in FIG. 7 comprises the following fields:

a transport speciffic (transportSpeciffic) field,

a message type (messageType) field,

three Reserved fields,

a version PTP (versionPTP) field,

a message length (messageLength) field,

a domain number (domainNumber) field,

a Flags field,

a correction field (correctionField),

a source port identity (sourcePortldentity) field,

a sequence identity (sequencel D) field,

a control field (controlField), and

a log message interval (logMessagelnterval) field,

As per IEEE P802.1AS-Rev/D7.3, it is specified that the destination address of announce and signaling messages shall be reserved a multicast address 01-80-C2-00-00-0E. Furthermore, also the destination MAC address of SYNC, Follow-Up, Pdelay_Request, Pdelay_Response and Pdelay_Response_Follow_Up which are all used for peer-to-peer synchronization shall be reserved the multicast address 01-80-C2-00-00-0E. It shall be noted that as per IEEE802.1Q, frames with this address may never be forwarded, non-forwardable address, but must be terminated by the bridge. As Source address they shall use the MAC address of any egress physical port.

### Multiple Time Domains in Industrial Application Scenario

As introduced above, the TSN domain works with different clocks, such as e.g. global and working clocks. Furthermore, the clocks of each TSN domain are not necessarily synchronized and a factory network may comprise of several TSN domains. Therefore, across a factory network there may be several independent TSN domains with arbitrary timescales where different, maybe overlapping subsets of devices, need to be synchronized. As shown in FIG. 8, each TSN domain may have its own working clock. FIG. 8 depicts four TNS domains. Each TSN domain represented by a line/cell also referred to as a working group, has its own working clock. A line/cell when used herein means a group of devices, e.g. robots, in the factory plant, often comprises a single machine or a set of neighbouring machines that physically collaborate, which means all devices within the group need to be synchronized and coordinated.

The four respective TNS domains 1, 2, 3 and 4 shown in FIG. 8, each has its own working clock, working clock domain 1, working clock domain 2, working clock domain 3, working clock domain 4.

### 3GPP Perspective to Provide Time Reference to UE

To satisfy time synchronization requirements for TSN in manufacturing use cases, a cellular network is required to provide a time reference, e.g. used for realizing time synchronization within the 5G system, to which all machines, such as e.g. sensors or actuators, can be synchronized. Currently in 3GPP standardization release 15 for LTE radio, a mechanism has been developed that allows time synchronization between Base Stations (BSs) and UEs with a sub-microseconds accuracy. It has been proposed in 3GPP RAN 2, to add two Information Elements (IE) into System Information Block (SIB) 16, such as e.g. time reference with a certain granularity, e.g. 0.25 μs, and an uncertainty value, and the DL Radio Resource Control (RRC) message UETimeReference to transmit a GPS time to the UE with three lEs added in an RRC message. The main purpose of this procedure is to transfer GPS based time reference information to UEs along with inaccuracy of that information.

### System Information Blocks (SIBs)

LTE defines several SIBs, related to timing information in SIB 16 or any other suitable SIBx, which contains information, such as time reference information, related to GPS time and Coordinated Universal Time (UTC). SIBs are transmitted over a Downlink Shared Channel (DL-SCH). The presence of a SIB in a subframe is indicated by the transmission of a corresponding Physical Downlink Control Channel (PDCCH) marked with a special System-Information RNTI (SI-RNTI). The Information Element (IE) SIB 16 contains information, such as time reference information, related to GPS time and UTC, e.g. the 5G system acquires GPS time or UTC which it then uses to realize time synchronization within the 5G system. The UE may use the parameter blocks to obtain the GPS and the local time.

The structure of the SIB 16 message is shown below:

SystemInformationBlockTypel6 information element

```
-- ASN1START
SystemInformationB1ockType16-r11 : := SEQUENCE {
  timeInfo-r11 SEQUENCE {
    timeInfoUTC-r11 INTEGER (0 . . . 549755813887),
    dayLightSavingTime-r11 BIT STRING (SIZE (2)) OPTIONAL,
    -- Need OR
    leapSeconds-r11 INTEGER (−127 . . . 128) OPTIONAL,
    -- Need OR
    localTimeOffset-r11 INTEGER (−63 . . . 64) OPTIONAL
    -- Need OR
  } OPTIONAL,
    -- Need OR
  lateNonCriticalExtension OCTET STRING OPTIONAL,
  . . . ,
  [ [ granularityOneQuarterUs-r15 INTEGER (0 . . . 36028797018963967)
    OPTIONAL, -- Need OR
    uncert-quarter-us-r15 INTEGER (0 . . . 3999) OPTIONAL
  ] ]
}
```

A proposed SIP Type 16 is shown in below Table 1:

SystemInformationBlockType16 field descriptions

dayLightSavingTime
Indicates if and how daylight saving time (DST) is applied to obtain the local time.
The semantics is the same as the semantics of the Daylight Saving Time IE in TS
24.301 [35] and TS 24.008 [49]. The first/leftmost bit of the bit string contains the b2
of octet 3, i.e. the value part of the Daylight Saving Time IE, and the second bit of the
bit string contains b1 of octet 3.
leapSeconds
Number of leap seconds offset between GPS Time and UTC. UTC and GPS time are
related i.e. GPS time -leapSeconds = UTC time.
localTimeOffset
Offset between UTC and local time in units of 15 minutes. Actual value = field value *
15 minutes. Local time of the day is calculated as UTC time + localTimeOffset.
granularityOneQuarterUs
Coordinated Universal Time corresponding to the SFN boundary at or immediately
after the ending boundary of the SI-window in which SystemInformationBlockType16
is transmitted. This field counts the number of GPS time in 0.25 us units since
00:00:00 on Gregorian calendar date 6 Jan. 1980 (start of GPS time).
timeInfoUTC
Coordinated Universal Time corresponding to the SFN boundary at or immediately
after the ending boundary of the SI-window in which SystemInformationBlockType16
is transmitted. The field counts the number of UTC seconds in 10 ms units since
00:00:00 on Gregorian calendar date 1 Jan. 1900 (midnight between Sunday,
Dec. 31, 1899 and Monday, Jan. 1, 1900). NOTE 1.
This field is excluded when estimating changes in system information, i.e. changes of
timeInfoUTC should neither result in system information change notifications nor in a
modification of systemInfoValueTag in SIB1.
uncert-quarter-us
Indicates the uncertainty of the reference time, where a value of ‘k’ indicates an
uncertainty of ±0.25 (k + 1) us, i.e., ‘0’ indicates an uncertainty of ±0.25 us, a value of
‘1’ indicates an uncertainty of ±0.5 us, and so on. The UE uses the value of this field
to determine how to interpret the value of the granularityOneQuarterUs field. For
example, if uncert-quarter-us = ‘3’ then the uncertainty is 2 us and the UE will interpret the
value of the granulatityOneQuarterUs field to be within the range
granularityOneQuarterUs ±2 us.

### Time Reference Information in RRC Signaling

Another way of providing time synchronization may be to use a time reference information message in RRC signaling to transmit the GPS time to the UE.

### Time Synchronization in 5G to Support TSN

The release 16 work is ongoing and different options are discussed to address the needs for time synchronization as required by TSN and industrial applications. Especially the support of multiple time domains in 5G is an open topic.

### SUMMARY

An object of embodiments herein is to improve the performance of a wireless communications network.

According to an aspect of embodiments herein, the object is achieved by a method, performed by a transmitting device in a wireless communication system, for handling generalized Precise Timing Protocol, gPTP, signaling, from a Time Sensitive Network, TSN. The transmitting device receives a gPTP message from a TSN network. The gPTP message comprises time information and a time domain related to the time information. The transmitting device extracts the time information and the time domain from the gPTP message. The transmitting device transmits a 3GPP message to a receiving device. The 3GPP message comprises the time information and the time domain related to the time information.

According to a further aspect of embodiments herein, the object is achieved by a method performed by a receiving device in a 3GPP wireless communication system, for handling generalized Precise Timing Protocol, gPTP, signaling, from a Time Sensitive Network, TSN. The receiving device receives a 3GPP message from a transmitting device. The 3GPP message comprises a time information and a time domain related to the time information. The receiving device creates a gPTP message based on the time information and the time domain comprised in the 3GPP message. The gPTP message comprises the time information and the time domain related to the time information. The receiving device transmits the gPTP message to one or more end stations in the TSN network. The gPTP message comprises the time information and the time domain related to the time information extracted from the 3GPP message.

According to an aspect of embodiments herein, the object is achieved by a transmitting device in a 3GPP wireless communication system, for handling generalized Precise Timing Protocol, gPTP, signaling, from a Time Sensitive Network, TSN. The transmitting device is configured to:
Receive from a TSN network, a gPTP message. The gPTP message comprises time information and a time domain related to the time information.
Extract the time information and the time domain from the gPTP message, and
transmit the 3GPP message to a receiving device. The 3GPP message comprises the time information and the time domain related to the time information.

According to a further aspect of embodiments herein, the object is achieved by a receiving device, in a wireless communication system, for handling generalized Precise Timing Protocol, gPTP, signaling, from a Time Sensitive Network, TSN. The receiving device is configured to:
Receive a 3GPP message from a transmitting device. The 3GPP message comprises a time information and a time domain related to the time information.
Create a gPTP message, based on the time information and the time domain comprised in the 3GPP message. The gPTP message comprises the time information and the time domain related to the time information.
Transmit, the gPTP message to one or more end stations in the TSN network, wherein the gPTP message comprises the time information and the time domain related to the time information extracted from the 3GPP message.

### BRIEF DESCRIPTION OF THE DRAWINGS

FIG. 1 is a block diagram illustrating a distributed TSN configuration model,

FIG. 2 is a block diagram illustrating a centralized TSN configuration model,

FIG. 3 is a block diagram illustrating a fully centralized TSN configuration model,

FIG. 4 is a flowchart illustrating a configuration of a TSN stream,

FIG. 5 is a schematic block diagram illustrating an overview of a 5G network architecture,

FIG. 6 is a schematic block diagram illustrating an exemplified 5G-TSN interworking architecture,

FIG. 7 is a table illustrating a PTP header format,

FIG. 8 is a block diagram depicting an exemplary use of multiple TSN gPTP time domains in a factory plant,

FIG. 9 is a schematic block diagram illustrating embodiments of a wireless communications network,

FIG. 10 is a schematic block diagram illustrating embodiments of a multiple time domain support in the 5GS,

FIG. 11 is a flowchart depicting a method performed by a transmitting device according to embodiments herein,

FIG. 12 is a flowchart depicting a method performed by a receiving device according to embodiments herein,

FIG. 13 is a schematic block diagram illustrating some first embodiments of a transmitting device,

FIG. 14 is a schematic block diagram illustrating some second embodiments of the transmitting device,

FIG. 15 is a schematic block diagram illustrating some first embodiments of a receiving device,

FIG. 16 is a schematic block diagram illustrating some second embodiments of the receiving device,

FIG. 17 is a schematic block diagram illustrating a host computer communicating via a base station with a user equipment over a partially wireless connection in accordance with some embodiments;

FIG. 18 is a schematic overview of a host computer communicating via a base station with a user equipment over a partially wireless connection in accordance with some embodiments;

FIG. 19 is a flowchart depicting methods implemented in a communication system including a host computer, a base station and a user equipment in accordance with some embodiments;

FIG. 20 is a flowchart depicting methods implemented in a communication system including a host computer, a base station and a user equipment in accordance with some embodiments;

FIG. 21 is a flowchart depicting methods implemented in a communication system including a host computer, a base station and a user equipment in accordance with some embodiments;

FIG. 22 is a flowchart depicting methods implemented in a communication system including a host computer, a base station and a user equipment in accordance with some embodiments.

### DETAILED DESCRIPTION

As part of developing embodiments herein, the inventors have identified a problem that first will be discussed.

gPTP messages are sent to synchronize slaves to a master. In gPTP, for example domain numbers are used to establish multiple time domains in parallel in a network. These numbers help a slave to synchronize its clock to a certain time domain master. Until now, there is no way a 5G system can efficiently support multiple time domains as required by industrial automation applications. This is particularly important in case a large number of domains need to be supported, such as e.g. 32 domains, and a large number of UEs are connected.

Depending on how time signals are transported in the 5GS, and especially what transmission type (Broadcast, Multicast, Unicast) is chosen at the RAN, RAN knowledge about which UE needs which time domain signal may be very important. This is however not supported today.

Some embodiments herein provide a method by which a UE and a BS e.g. a network node, may provide multiple time signals to e.g. a TSN application running either on UE side or BS side and then let the 5GS know to which time domain a signal belongs to.

It is herein assumed that 5GS internal signaling is used to transport time information. In this case the 5GS may act as a gPTP time-aware device (which is defined to be compliant with an IEEE1588 boundary clock)—it may use ingress gPTP frames to get time aware itself or may have separate gPTP instances handling the 5G system clock, such as e.g. the clock used for time reference within the 5GS, and external TSN clocks. An internal signaling in the RAN and Core may be used to transport the relevant gPTP information internally and when received by the UE it may then act as a gPTP master at the UE egress. The 5GS in this case must support and participate in all Best Master Clock Algorithms (BMCAs), (one gPTP instance per gPTP domain must operate in this case) or being configured to its gPTP role by an external entity. A simplified option is possible where a static BMCA is implemented. The actual operation of the BMCA is out of the scope of this disclosure, but embodiments identified herein support the transfer of the related information received via Announce messages. Generation of Announce messages may also be required at the 5GS interfaces or at the internal interfaces of the 5GS nodes, if cascaded time-aware systems are implemented.

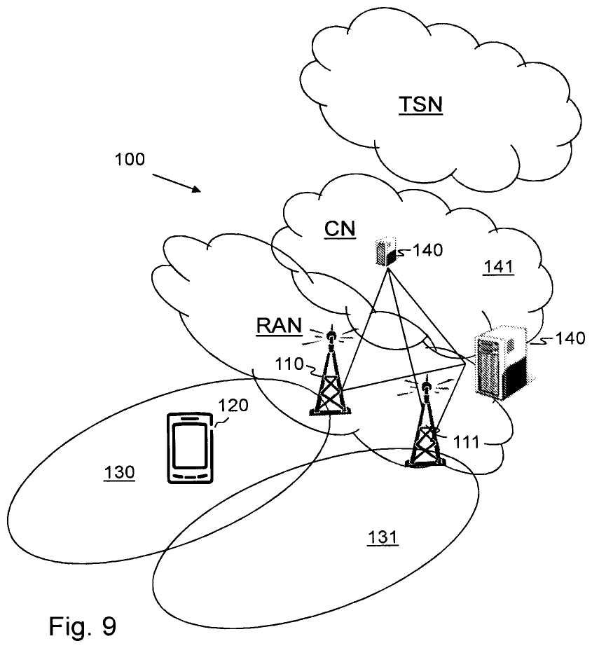

FIG. 9 depicts an example of a communications network 100 according to a first scenario in which embodiments herein may be implemented. The communications network 100 is a wireless communication network such as e.g. a 5GS, an LTE, E-Utran, WCDMA, GSM network, any 3GPP cellular network, Wimax, or any cellular network or system.

The communications network 100 comprises a Radio Access Network (RAN) and a Core Network (CN). The communication network 100 may use a number of different technologies, such as Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), Wi-Fi, or Ultra Mobile Broadband (UMB), just to mention a few possible implementations. In the communication network 100, one or more UEs 120 may communicate via one or more Access Networks (AN), e.g. RAN, to one or more CNs. The UE 120 may e.g. be a wireless device (WD), a mobile station, a non-access point (non-AP) STA, a STA, and/or a wireless terminal. It should be understood by those skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a base station communicating within a cell.

The UEs 120 may each be connected to one or more end stations. The end stations may e.g. be robots on a factory floor. In some embodiments, the UE 120 is connected to a group of end stations. One example of implementation may be a group of end stations being connected to a bridge, which bridge is connected to the UE 120.

The RAN comprises a set of radio network nodes, such as radio network nodes 110, 111 each providing radio coverage over one or more geographical areas, such as a cell 130, 131 of a radio access technology (RAT), such as 5g, LTE, UMTS, Wi-Fi or similar. The radio network node 110, 111 may be a radio access network node such as radio network controller or an access point such as a wireless local area network (WLAN) access point or an Access Point Station (AP STA), an access controller, a base station, e.g. a radio base station such as a gNB, a NodeB, an evolved Node B (eNB, eNodeB), a base transceiver station, Access Point Base Station, base station router, a transmission arrangement of a radio base station, a stand-alone access point or any other network unit capable of serving a wireless device within the cell, which may also be referred to as a service area, served by the radio network node 110, 111 depending e.g. on the first radio access technology and terminology used.

The CN further comprises a core network node 140 which is configured to communicate with the radio network nodes 110, 111, via e.g. an S1 interface. The core network node may e.g. be a Mobile Switching Centre (MSC), a Mobility Management Entity (MME), an Operations & Management (O&M) node, an Operation, Administration and Maintenance (OAM) node, an Operations Support Systems (OSS) node and/or a Self-Organizing Network (SON) node. The core network node 140 may further be a distributed node comprised in a cloud 141.

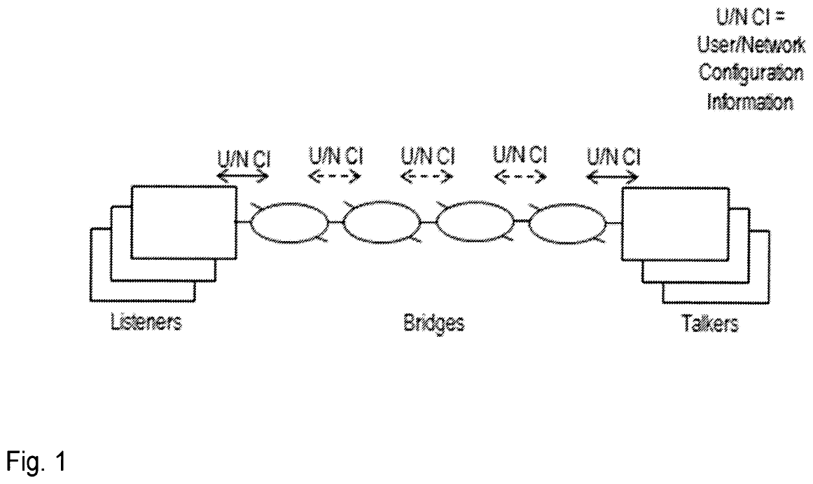

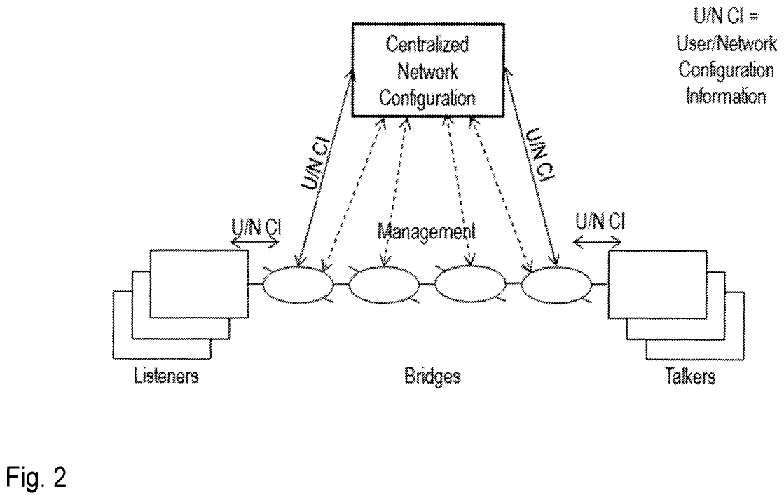

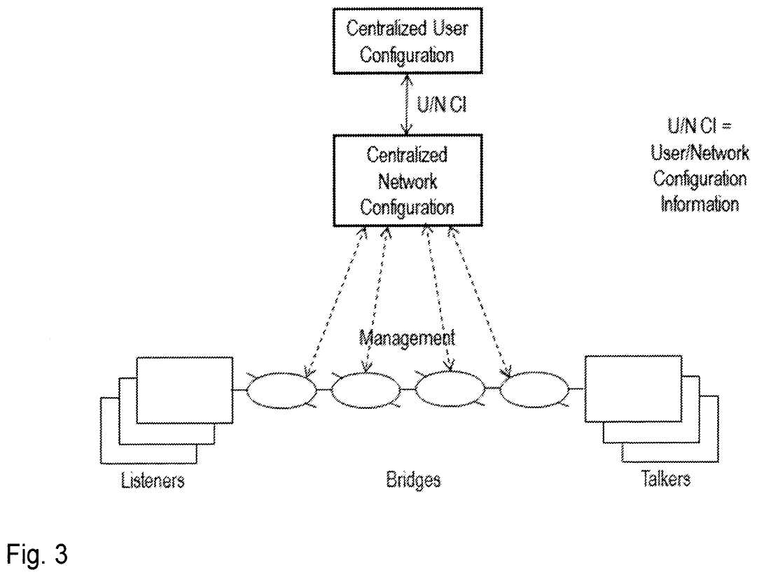

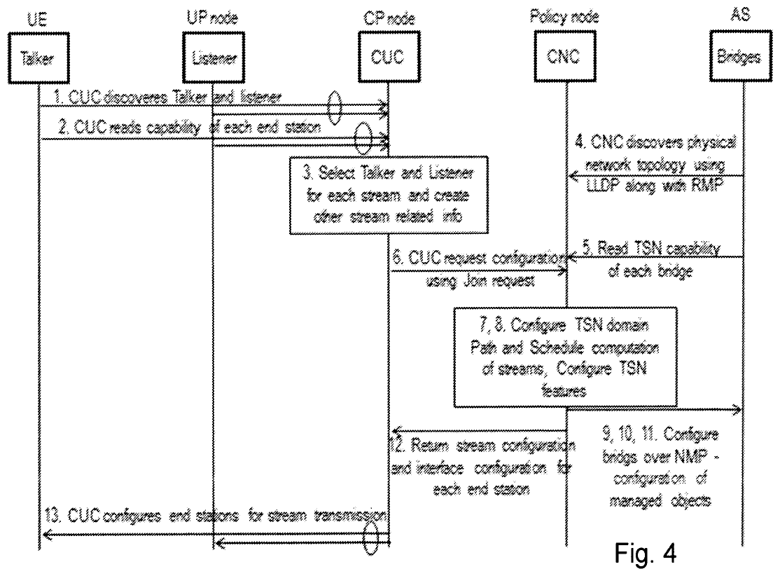

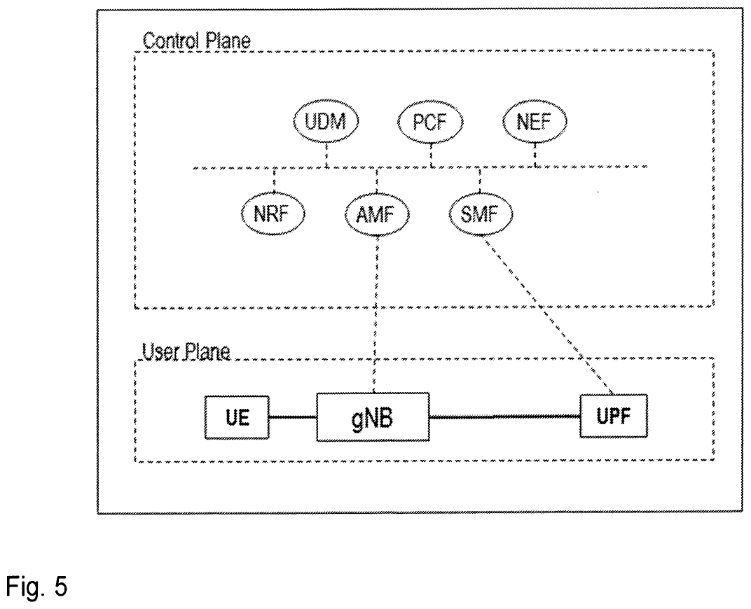

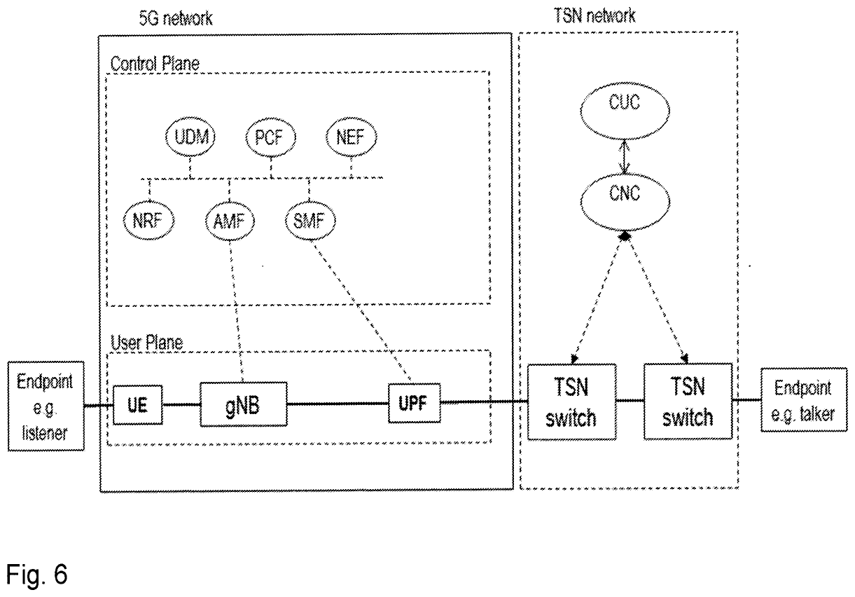

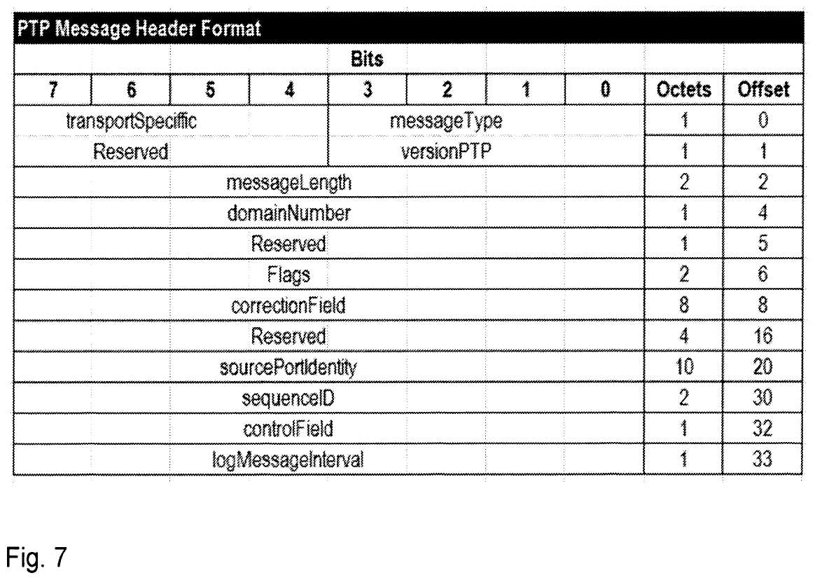

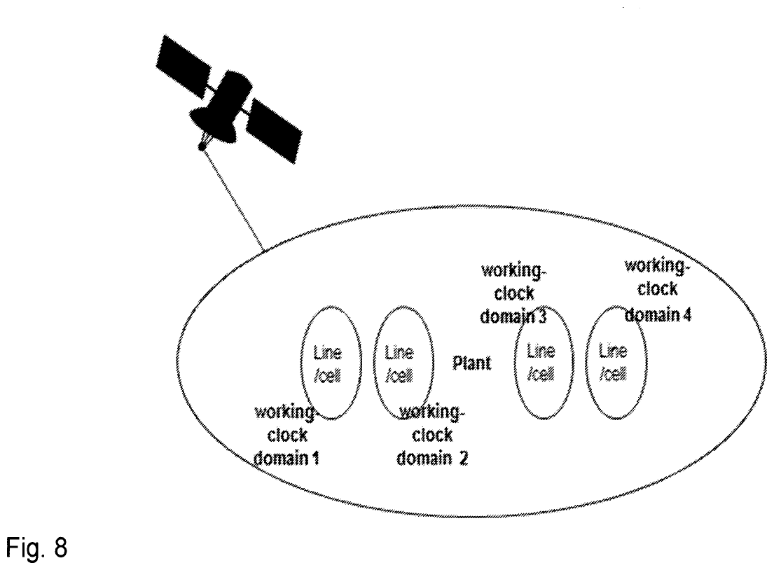

The UE 120 is located in the cell 130 of the network node 110, which is referred to as the serving cell, whereas the cell 131 of the network nodes 111 are referred to as neighboring cells. Although, the network node 110 in FIG. 1 is only depicted providing a serving cell 130, the network node 110 may further provide one or more neighboring cells 131 to the serving cell 130.

The communications network 100 may according to some embodiments herein communicate with nodes in an external TSN network. The TSN network may be connected to one or more end stations.

Note that although terminology from 3GPP 5G has been used in this disclosure to exemplify the embodiments herein, this should not be seen as limiting the scope of the embodiments herein to only the aforementioned system. Other wireless systems, including WCDMA, WiMax, UMB, GSM network, any 3GPP cellular network or any cellular network or system, may also benefit from exploiting the ideas covered within this disclosure.

In the following, the embodiments herein will be described in further detail.

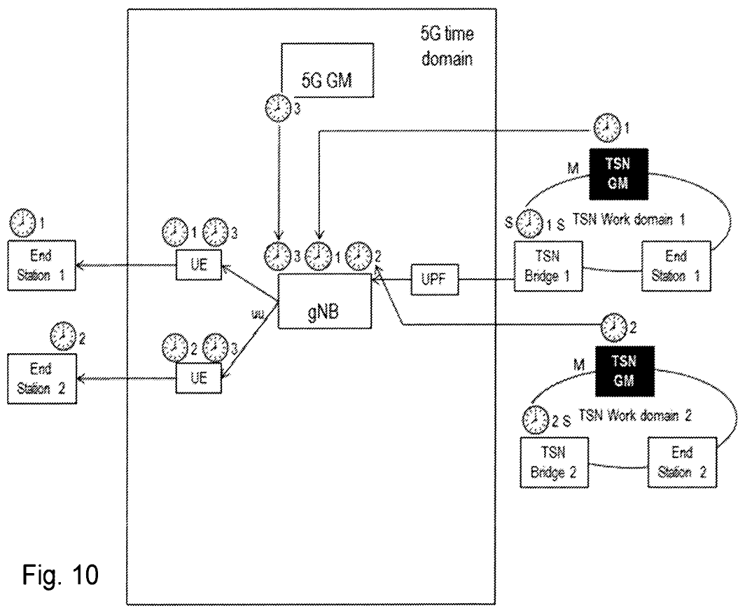

According to the embodiments herein the communications network 100, in this example a 5GS may receive gPTP messages from an external network, such as e.g. a TSN network, in which a GM is deployed. The gPTP messages from a GM may be received either on a UE, such as the UE 120, or UPF side of the 5GS. As multiple time domains are used in industrial networks as introduced above, there may be multiple signals arriving at the 5GS. One example scenario of multiple time domain support in the 5GS for a scenario in which the grandmaster is located on the UPF-side of the 5GS according to embodiments herein is illustrated in FIG. 10. FIG. 10 depicts two external networks, TSN network domain1 and TSN network domain 2. The TSN network domain 1 comprises a TSN GM using working clock 1. Actually every node in a working clock domain, e.g. TSN bridgel, End-station1, has a working clock 1, those clocks are synchronized with the Grand Master clock 1, TSN GM, also referred to as TSN Grand Master clock 1. The TSN network domain 1 further comprises a TSN bridge 1 and an end station 1. The TSN network domain 2 comprises a TSN GM using working clock 2, a TSN bridge 2 and an end station 2. A 5G GM in a 5G time domain uses a working clock 3. One UE operating in the 5G time domain, such as e.g. the UE 120, is connected to an end station 1, in this example using the working clock 1. Another UE operating in the 5G time domain, such as e.g. the UE 120, is connected to an end station 2 in this example using the working clock 2. In FIG. 10, M means Master and S means Slave.

In FIG. 10 gPTP messages are directly transported to a gNB, such as e.g. the network node 110, which is one possible implementation. Any gPTP message comprises a domain number which defines the time domain which the gPTP message belongs to.

The embodiments herein assume a non-transparent transport of gPTP frame, such as e.g. a gPTP message, in the 5GS is used, in other words the information is extracted from gPTP frames and relayed through the 5GS using 3GPP signalling. The information about the time domains and which UE belongs to which time domain is particularly important for cases where a large number of UEs are connected and a significant number of gPTP domains need to be supported, such as e.g. more than two gPTP domains. The non-transparent transport of gPTP frame through the 5GS, i.e. from the transmitting device to the receiving device, is subject to a 5GS residence time and determining a value for the 5GS residence time used for ensuring time information carried within a gPTP frame may be modified to become synchronized with the source GM node. This may e.g. be realized by the transmitting device performing an ingress timestamp, using the clock that serves as the time reference, indicating the time at which it receives time information from the TSN network and including the ingress timestamp as part of the time information it sends to the receiving device. The receiving device may perform an egress timestamp, e.g. by using the clock that serves as the time reference, to thereby derive the time difference between the ingress timestamp indicated by the 3GPP message and the point at which the time information is sent to one or more end stations, i.e. the time difference is the 5GS residence time, and may include the time difference as part of the time information.

### Grandmaster on UPF Side of the 5GS-Downlink

Either the UPF or the gNB, such as e.g. the network node 110, may receive gPTP messages and may act as a slave to the external TSN network. Hence, one specific gPTP instance, such as e.g. an instantiation of a gPTP application, implemented in either the UPF or in a gNB may handle the gPTP messages belonging to that specific gPTP domain, as indicated by the domainNumber attribute, and, as a result of for example a BMCA for the specific gPTP domain, lock to the related GM. In case the UPF provides the instantiation, the UPF will forward the time information extracted from the gPTP message to one or more gNB(s) plus the information about the time domain it belongs to. The UPF may e.g. be configured with a set of Ethernet MAC multicast addresses for which it will relay corresponding time information and time domain information to one or more gNBs. Note that when the UPF acquires the timing information, such as e.g. an external TSN working clock value and a corresponding time domain, from gPTP messages it relays it to the gNB for further distribution to the UE, such as e.g. the UE 120. The actual gPTP messages are not relayed. Different options are available for transmitting timing information in RAN, in particular, not necessarily requiring involvement of the gNB. For example, in case a distributed time-aware approach is implemented, only the devices at the edges of the 5GS may need to handle and process the gPTP messages. However, the embodiments herein focus on the case where RAN is necessarily involved and uses SIB based or RRC based methods for conveying timing information to UEs.

If a radio broadcast (for example SIB messages) is used in the RAN:

The UEs, such as e.g. the UE 120, need to know which broadcasted signal belongs to which time domain. Each time domain may be broadcasted individually, or one broadcast signal may carry information for multiple time domains.

In one embodiment this may for example be solved by adding an additional parameter sent in the SIB signals to UEs, such as e.g. the UE 120, that indicate the domainNumber, such as e.g. an integer between for example 0-127; either in each broadcasted signal or multiple in one signal.

In another embodiment, the broadcasted signal does not carry any additional parameter, but when broadcasted, it always carries a specific time domain signal such as of domain 0 or a list of domain numbers such as domain 0, 1, 2, . . . , N. Which domain number or which list of the domain numbers that is sent in the broadcast message may be preconfigured or may be sent to the UE, such as e.g. the UE 120, prior to sending the broadcast message with timing information.

According to yet another embodiment, the UE, such as e.g. the UE 120, may learn which time domain(s) an end station or end stations which the UE is connected to require(s). The UE may e.g. learn this by listening to the gPTP Announce messages delivered periodically by the end station(s). As a result of the BMCA, the UE will implement a PTP port operating in the master state forwarding time signals from the 5G network and will only operate in the specific PTP domain that it needs to support. This means that the UE will only select the time domains from the broadcasted time signal information that it requires.

In one way, the 5GS may obtain information from a TSN network controller about which time domain signal that needs to be directed to which UE, such as the UE 120, e.g. by means of an UE identifier, or a MAC address of an end station connected to the UE respectively. The information may for example be sent from the external TSN CNC towards an Application Function (AF) when the CNC sets up TSN domains in the TSN network. The CNC may announce which time domain signals that need to be forwarded to which port, such as e.g. to a UE or a MAC address. The AF may trigger SMF or AM F or another core network function to tell the UEs, such as e.g. the UE 120, which time domain signal they should listen to. In detail:

1. The CUC may know exactly what clock domain an end station desires.

2. The CUC may then tell the CNC to configure a 5G “bridge”, i.e. the 5G system modeled as a bridge/time aware relay. The CNC may e.g. ask 5GS to setup a link between northbound, such as 5GS ingress, of 5G bridge and southbound, such as 5GS egress, of the 5G bridge, so that the correct timing can be delivered to the corresponding end station. In downlink direction Northbound of 5G is any nodes on the TSN side of the UPF, southbound is any nodes on the device side of the UE. In an uplink direction the Northbound of 5G is any nodes on the device side of the UE, southbound is any nodes on the TSN side of the UPF. In a UE-UE communication case, the UE receiving incoming traffic is the northbound, and the UE forwarding traffic to next TSN bridge or end station is the southbound.

3. The 5GS may receive the AF information from the CNC and may translate the CNC command to 5GS signaling. This may be referred to as an external port configuration that may be performed by a CNC e.g. to define a gPTP rapid spanning tree, or any other spanning tree, inside a switch, or inside the 5GS according to the embodiments herein. A gPTP message is an Ethernet frame, it follows IEEE802.1 spanning tree protocol, defined in IEEE802.1Q standard. If the external port configuration is available as information from the CNC then the BCMA is no longer required. Ports may be configured by the CNC to take different roles, such as e.g. MasterPort, SlavePort, PassivePort, or DisabledPort, which may be interpreted into where each time domain signal needs to be routed in the 5GS according to the IEEE P802.1AS-rev standard. The 5GS internal signaling from the AF may be used e.g. to inform UEs, such as e.g. the UE 120, about which time domain signal they should listen to in case a broadcast is used.

If a radio multicast or unicast (using e.g. RRC signaling) is used:

The gNB or gNBs, such as e.g. the network node 110, in general needs to know which UE or UEs requires which time signal from which time domain.

According to one embodiment, this may be achieved by sending a signal from the UE, such as e.g. the UE 120, to the gNB, such as e.g. the network node 110, about which time domain the UE is interested in, or more precisely which time domain the end station or end stations connected to the UE are interested in. This information is available in the end station the UE is connected to, since each device knows which time signal it should listen to. Methods from BCMA may be used to obtain said information. This may be a single or multiple time domains depending on how the UE is connected, such as e.g. to a single end station or a switch followed by multiple end stations, and methods like the ones described in relation to the broadcasting case are valid to learn the interests of end-stations. The gNB may query the UE information about the time domain the UE requires or the UE may send the information about which time domain it requires to the gNB after being connected to the network. This may e.g. be performed using RRC messaging between the UE and the gNB(s).

According to another embodiment, the UE, such as e.g. the UE 120, may be manually configured to a specific time domain or time domains and the information about the time domain the UE requires may be available at a core network function. A UE 5G internal identifier may be used to query a database, e.g. in the 5GS, wherein it is noted in the database which time domains the UE is to be synched to. The gNB, such as e.g. the network node 110, may query a core network function. The core network function may tell the gNB which UE requires which time domain signal. One solution may be that the SMF provides this information to the RAN when a PDU session is setup. As for the broadcast case this configuration or information about which time domain signal needs to be forwarded to which UE may be received from an external TSN CNC (external port configuration) during the TSN domain setup phase e.g. through the AF. This information may be internally forwarded in the 5GS to the RAN, in order to let the RAN know which UE needs which time domain signal. The UE will only receive a time signal or signals that it is required to forward to other devices since only these signals may be sent to the UE by the gNB. In order to separate different time signals that are sent to the UE, identifiers may be negotiated between the UE and the gNB or may be pre-configured to allow the UE to distinguish between different time domains and forward gPTP frames accordingly, i.e. put the right domainNumbers into the gPTP frames. The pre-configuration may be such that the domain number is not signaled in the unicast RRC message but the UE is aware of which domain number the message refers to. If there is only one time domain supported by the UE, this is straightforward. If there are multiple time domains supported by the UE, the unicast message may include a list of time information ordered in, for example, an ascending or descending order of the time domain number.

### General

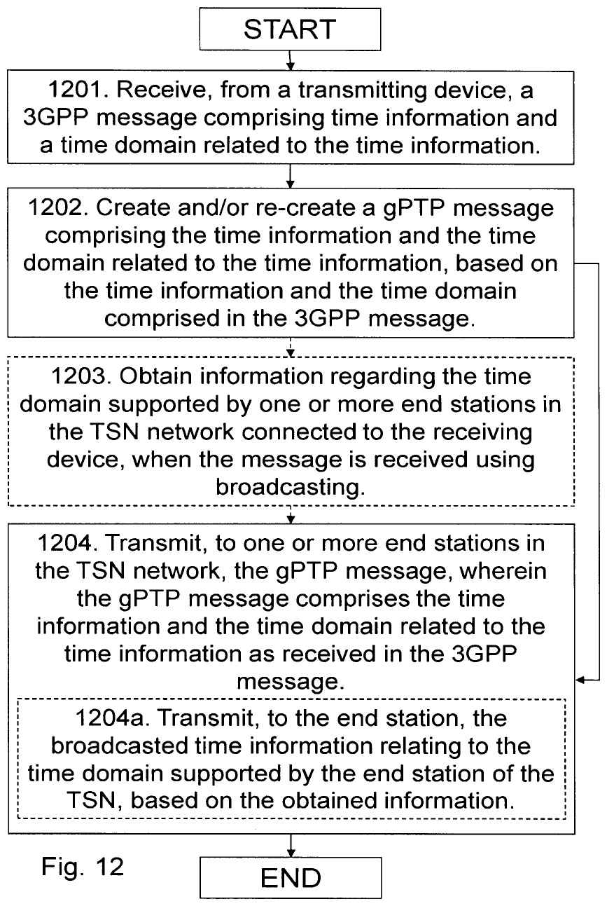

At the egress of the 5GS, i.e. when the message leaves the 5GS, the UE, such as e.g. the UE 120, may act as a gPTP master to any device connected to it. This may involve a creation or re-creation of various gPTP frames such as gPTP messages, such as e.g. Sync, Follow_up, Pdelay_request, Pdelay_response, PDelay_Response_Follow_up, Announce etc., based on the timing and other information, such as e.g. domainNumbers, from a gNB. This is similar to action 1202 described below with regards to the method performed by the receiving device in FIG. 12.

For all the embodiments mentioned above it is not important how the time signals are transported in the RAN (i.e. which signals are used and how these signals are designed to achieve a sufficient accuracy), besides whether it is unicasted, multicasted or broadcasted.

For all embodiments mentioned above it may further be relevant to also transmit other gPTP information to/from the UE, e.g. the UE 120, such as e.g. information related to the handling of BMCA and related information required to generate the outgoing PTP messages, such as e.g. a clock identifier. This may be the case in all three cases described above, i.e. broadcast, multicast, and unicast, either as dedicated RRC or SIB signaling next to the time signal transmission or as part of the time signaling in RRC or SIB messages.

Furthermore, an Internet Protocol (IP) may be used for transporting the gPTP frames, such as the gPTP messages. All methods in here may be applicable in a similar manner in this case where IP is used above Ethernet on Layer 3 (L3).

### Grandmaster on the UE Side of the 5GS-Uplink

When the grandmaster is on the UE side of the 5GS, then the UE, such as e.g. the UE 120, needs to forward time information to the gNB, such as e.g. the network node 110. The UE may receive gPTP messages and is therefore time aware. The 5GS needs to be informed about which time domain a transmitted signal belongs to. Only unicast, such as e.g. using RRC signaling, is possible in uplink.

In one embodiment, the 5G network may be informed about the time domain by means of a dedicated RRC signaling from the UE, such as e.g. the UE 120, to the gNB, such as e.g. the network node 110, that indicates the time domain number. When multiple time domains are present the dedicated RRC signaling may comprise multiple time domain numbers. The gNB may receive this information and either forward it to the UPF or may use it itself in order to forward the timing information from the UE to the correct time domain, in order to ultimately re-establish gPTP frames, such as the gPTP messages, with the correct domainNumber. The RRC signaling may be performed as part of the time signaling or may be negotiated beforehand. If it is negotiated that the UE will signal time from multiple time domains an identifier may be used to distinguish the time domains within the time signals.

According to a further embodiment the time domains may also be pre-configured (UE #12345 may be configured to only uplink a time domain signal belonging to time domain i). If it is pre-configured that the UE, such as e.g. the UE 120, will signal time from multiple time domains, an identifier may be used to distinguish them. A pre-configuration may also be performed as described in the embodiments above, based on input from an external TSN CNC e.g. through the AF as explained for the downlink embodiments.

The embodiments herein have the benefit that they allow end-to-end time synchronization with multiple time-domains. Thereby the 5GS system is now able to forward time signals from multiple time domains efficiently.

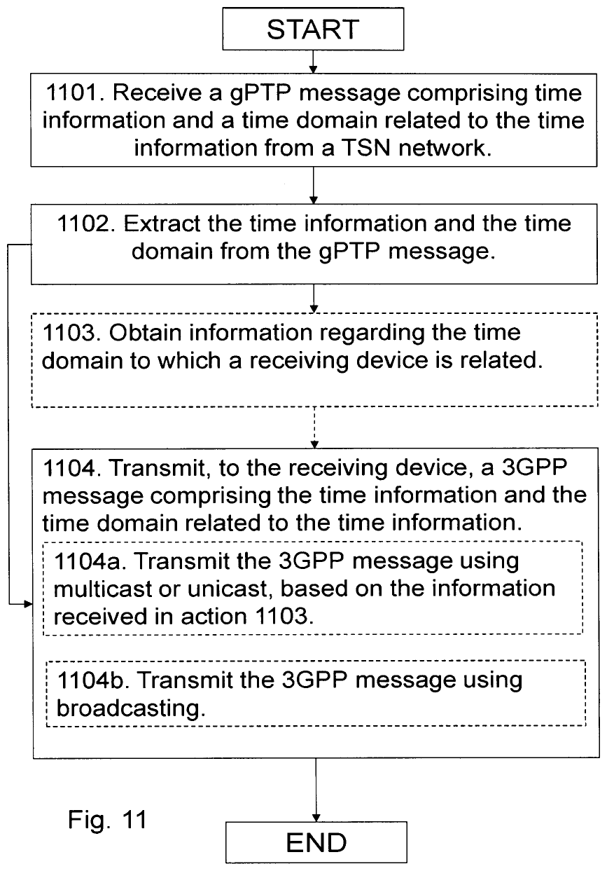

FIG. 11 depicts a method according to example embodiments herein seen in the respective view of a transmitting device and FIG. 12 depicts methods according to example embodiments herein seen in the respective view of a sending device.

The transmitting device may e.g. be a transmitting device X010, such as e.g. the UE 120 during UL transmissions or the network node 110 or the UPF during DL transmissions.

The receiving device is connected to one or more end stations. The receiving device may e.g. be a receiving device X020, such as e.g. the UE 120 connected to one or more end stations during DL transmissions, or the radio network node 110 or the UPF connected to the one or more end stations during UL transmissions. The TSN network uses multiple time domains, whereof one or a few time domains are related to the gPTP frame.

FIG. 11 illustrates example method actions performed by the transmitting device, in the wireless communication system 100, for handling gPTP signaling from the TSN.

Action 1101:

The transmitting device may receive a gPTP message from a TSN network. The gPTP message comprises time information and a time domain related to the time information.

Action 1102:

The transmitting device extracts the time information and the time domain from the gPTP message.

Action 1103: In some embodiments, the transmitting device may obtain information regarding the time domain to which a receiving device is related. This may e.g. be performed to improve efficiency of transmitting gPTP messages or related timing information. So, if for example, no Action 1103 were performed, End station 1 at UE side would receive gPTP messages from both working clock domain 1 and clock domain 2, then End station 1 discards clock domain 2 messages. With action 1103, the End station 1 will only receive gPTP messages for working clock domain 1.

The information regarding the time domain to which a specific device is related may be obtained by receiving a signal from the receiving device indicating which time domain the receiving device is related to e.g. by means of RRC signaling. The indication may e.g. be signaled by means of RRC signaling. In some embodiments the receiving device may be preconfigured with one or more specific time domains and the information regarding the time domain to which the receiving device is related may be obtained by the transmitting device by querying, i.e. by sending a query to, a database comprising the time domains that the specific receiving device is configured to support. The time domain comprised in the 3GPP message may be indicated using an identifier. The identifier may be used when querying the data base.

Action 1104: The transmitting device further transmits a 3GPP message to the receiving device. The 3GPP message comprises the extracted or obtained time information and the time domain related to the time information. The 3GPP message may e.g. be a Session Initiation Protocol (SIP) message used for broadcasting or a Radio Resource Control (RRC) message. By including the extracted or obtained time information and time domain related to the time information in a 3GPP message and sending it to the receiving device, the receiving device in the 3GPP network will know to which time domain a signal belongs.

The transmitting device may also make a timestamp using the clock that serves as the time reference to indicate the ingress timestamp at which the time information is received from the TSN network and include this ingress timestamp as part of the time information carried by the 3GPP message.

Since a 3GPP message is used, the receiving device here may be a 3GPP device and not a TSN node, otherwise, non-3GPP device won't understand 3GPP message. For non-3GPP reviving device the communication should be gPTP message.

Action 1104a:

In some embodiments, the transmitting device may transmit the 3GPP message comprising the time information and the time domain related to the time information to one or more receiving devices related to the time domain comprised in the 3GPP message using multicast or unicast, based on the information received in action 1103. This may be performed to improve efficiency of transmitting gPTP messages or related timing information, this is the case if the timing information is in a 3GPP message.

Action 1104b:

When the transmitting device is a radio network node or a UPF, the transmitting device may transmit the 3GPP message to the receiving device using broadcasting. The transmission device may transmit an additional parameter or e.g. a dedicated signaling-in the 3GPP message. The additional parameter may indicate the time domain or a time domain number which the broadcasted 3GPP message relates to. This may be performed to give TSN end-stations freedom to select their desired time domain information. This is the case where Action 1103 is not performed.

FIG. 12 illustrates the method actions performed by the receiving device in the 3GPP wireless communication system, such as e.g. the 5G system, for handling gPTP signaling from the TSN. The receiving device may herein also be referred to as a receiving entity.

Action 1201:

The receiving device may receive a 3GPP message from a transmitting device. The 3GPP message comprises time information and a time domain related to the time information. Since the transmitting device has included the time information and the time domain related to the time information in a 3GPP message, the receiving device in the 3GPP network will know to which time domain a signal belongs. The 3GPP message may be received using multicasting, unicasting or broadcasting.

Action 1202:

Based on the time information and the time domain comprised in the 3GPP message and e.g. the delay experienced in sending the 3GPP message from the transmitting device to the receiving device, the receiving device may create and/or re-create, a gPTP message comprising the time information and the time domain related to the time information.

Action 1203:

When the 3GPP message is received as a broadcasted message, the receiving device may further obtain information regarding the time domain supported by the one or more end stations in the TSN network, which end stations are connected to the receiving device. The information regarding the time domain supported by the end stations in the TSN, may e.g. be obtained by receiving a gPTP message, such as e.g. a gPTP Announce message, delivered periodically by the end station. The information regarding the time domain supported by the end stations in the TSN, may in a further embodiment be obtained by receiving information from a TSN network controller, wherein the information comprises a receiving device identifier, such as e.g. a UE identifier, or a MAC address of an end station.

Action 1204:

The receiving device may transmit a gPTP message to one or more end stations in the TSN network, e.g. connected to the receiving device. The gPTP message comprises the time information and the time domain related to the time information extracted from the 3GPP message, and in some embodiments the delay experienced in sending the 3GPP message from the transmitting device to the receiving device.

The receiving device may perform an egress timestamp using the clock that serves as the time reference to thereby derive the time difference between the ingress timestamp indicated by the 3GPP message and the point at which the time information is sent to one or more end stations. The receiving device may include the time difference as part of the time information.

Action 1204a: The receiving device may transmit, to the end station, e.g. the recreated gPTP message, or the broadcasted time information relating to the time domain supported by the end station of the TSN, based on the information obtained in action 1203. Hence, any broadcasted time information not relating to the time domain supported by the end station of the TSN which is connected to the receiving device will not be transmitted to the end station by the receiving device.

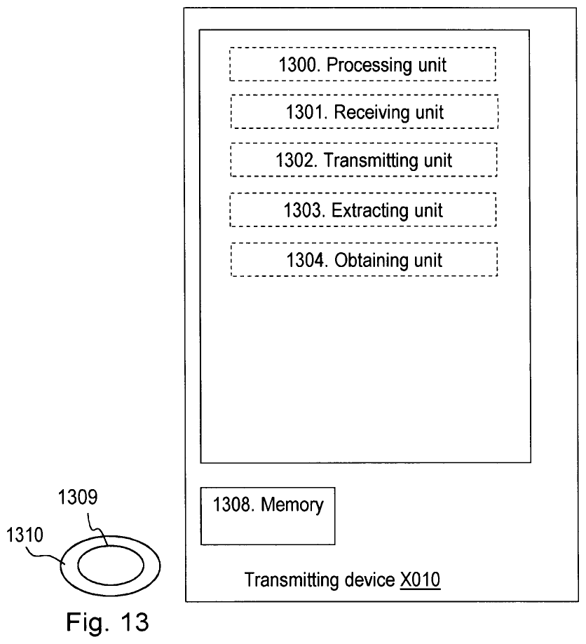

FIG. 13 is a block diagram depicting the transmitting device X010 in a 3GPP wireless communication system 100, for handling gPTP signaling from a TSN.

As mentioned above, the transmitting device X010, may be the UE 120 during UL transmissions or the network node 110 or the UPF during DL transmissions, and the 3GPP wireless communication system 100, may e.g. be a 5G system.

The transmitting device X010 may comprise a processing unit 1300, such as e.g. one or more processors, a receiving unit 1301, a transmitting unit 1302, an extracting unit 1303, an obtaining unit 1304 as exemplifying hardware units configured to perform the method as described herein for the transmitting device X010.

The transmitting device X010 may be configured to, e.g. by means of the processing unit 1300 and/or the receiving unit 1301 being configured to, receive, from a TSN network, a gPTP message, wherein the gPTP message comprises time information and a time domain related to the time information.

The transmitting device X010 may be configured to, e.g. by means of the processing unit 1300 and/or the extracting unit 1303 being configured to, extract the time information and the time domain from the gPTP message.

The transmitting device X010 may be configured to, e.g. by means of the processing unit 1300 and/or the transmitting unit 1302 being configured to, transmit, to a receiving device, such as e.g. the radio network node 110, the UPF and/or the UE 120, a 3GPP message comprising the time information and the time domain related to the time information.

The transmitting device may be configured to, e.g. by means of the processing unit 1300 and/or the transmitting unit 1302 being configured to, transmit the 3GPP message to the receiving device using multicast or unicast.

When the transmitting device is configured to transmit the 3GPP message to the receiving device using multicast or unicast, the transmitting device may be configured to, e.g. by means of the processing unit 1300 and/or the obtaining unit 1304 being configured to, obtain information regarding the time domain to which the receiving device is related.

When the transmitting device is configured to transmit the 3GPP message to the receiving device using multicast or unicast, the transmitting device may be configured to, e.g. by means of the processing unit 1300 and/or the transmitting unit 1302 being configured to, transmit the 3GPP message comprising the time information and the time domain related to the time information to one or more receiving devices related to the time domain comprised in the 3GPP message, based on the obtained information.

When the transmitting device is a radio network node or a UPF, and the 3GPP message is transmitted using broadcasting, the transmitting device may further be configured to, e.g. by means of the processing unit 1300 and/or the transmitting unit 1302 being configured to, transmit to the receiving device, an additional parameter or a dedicated signaling in the 3GPP message, which additional parameter indicates the time domain or a time domain number which the broadcasted 3GPP message relates to.

The transmitting device may further be configured to, e.g. by means of the processing unit 1300 and/or the transmitting unit 1302 being configured to, transmit the 3GPP message to the receiving device using multicast or unicast,

The transmitting device may further be configured to, e.g. by means of the processing unit 1300 and/or the obtaining unit 1304 being configured to, obtain the information regarding the time domain to which a specific device is related by being configured to, e.g. by means of the processing unit 1300 and/or the receiving unit 1301 being configured to, receive a signal from the receiving device comprising the time domain which the receiving device is related to. The transmitting device may e.g. be configured to receive the signaling by means of RRC signaling.

The transmitting device may be configured to, e.g. by means of the processing unit 1300 and/or the obtaining unit 1304 being configured to, obtain the information regarding the time domain to which the receiving device is related is by querying a database comprising the time domains that the specific receiving device is configured to support, and wherein the time domain comprised in the 3GPP message is indicated using an identifier.

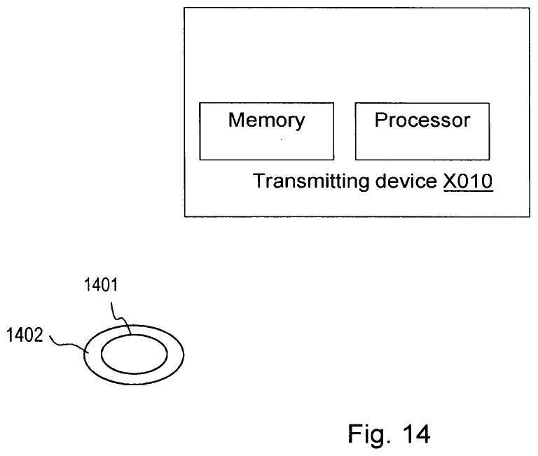

The embodiments herein may be implemented through a respective processor or one or more processors of a processing circuitry in the transmitting device X010 as depicted in FIG. 14, which processing circuitry is configured to perform the method actions according to FIG. 11 and the embodiments described above for the transmitting device X010.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the transmitting device X010. One such carrier may be in the form of a CD ROM disc. It is however feasible with other data carriers such as e.g. a memory stick. The computer program code may furthermore be provided as pure program code on a server and downloaded to the transmitting device X010.

The transmitting device may further comprise a memory 1308. The memory may comprise one or more memory units to be used to store data on, such as e.g. information regarding the retransmissions, PUSCH resource table, software, patches, system information (SI), configurations, diagnostic data, performance data and/or applications to perform the methods disclosed herein when being executed, and similar.

The method according to the embodiments described herein for the transmitting device X010 may be implemented by means of e.g. a computer program product 1309, 1401 or a computer program, comprising instructions, i.e., software code portions, which, when executed on at least one processor, cause at least one processor to carry out the actions described herein, as performed by the transmitting device X010. The computer program product 1309, 1401 may be stored on a computer-readable storage medium 1310, 1402, e.g. a disc or similar. The computer-readable storage medium 1310, 1402, having stored thereon the computer program, may comprise instructions which, when executed on at least one processor, cause the at least one processor to carry out the actions described herein, as performed by the transmitting device X010. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of the transmitting device X010.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

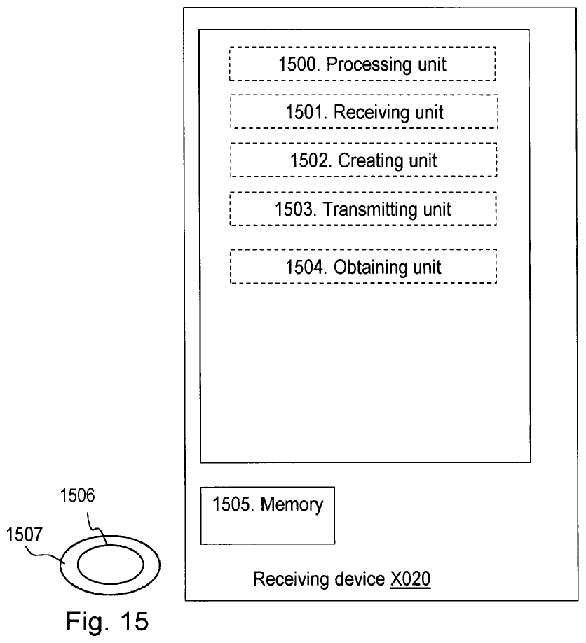

FIG. 15 is a block diagram depicting the receiving device X020, such as e.g. the UE 120 during DL transmissions or the radio network node 110 or the UPF during UL transmissions, in a wireless communication system 100, such as e.g. a 5G system, for handling gPTP signaling from a TSN.

The receiving device X020 may comprise a processing unit 1500, such as e.g. one or more processors, a receiving unit 1501, a creating unit 1502, a transmitting unit 1503 and/or an obtaining unit 1504 as exemplifying hardware units configured to perform the method as described herein for the receiving device X020.

The receiving device X020 may be configured to, e.g. by means of the processing unit 1500 and/or the receiving unit 1501 being configured to, receive, from a transmitting device, such as e.g. the UE 120 during UL and/or the network node 110 or the UPF during DL, a 3GPP message comprising a time information and a time domain related to the time information.

The receiving device X020 may be configured to, e.g. by means of the processing unit 1500 and/or the creating unit 1502 being configured to, create and/or re-create a gPTP message comprising the time information and the time domain related to the time information, based on the time information and the time domain comprised in the 3GPP message.

The receiving device X020 may be configured to, e.g. by means of the processing unit 1500 and/or the transmitting unit 1503 being configured to, transmit, to one or more end stations in the TSN network, the gPTP message, wherein the gPTP message comprises the time information and the time domain related to the time information extracted from the 3GPP message.

The receiving device X020 may be configured to, e.g. by means of the processing unit 1500 and/or the receiving unit 1501 being configured to, receive the 3GPP message is received as a broadcasted message.

The receiving device X020 may be configured to, e.g. by means of the processing unit 1500 and/or the obtaining unit 1504 being configured to, obtain information regarding a time domain supported by the one or more end stations in the TSN network, which end stations the receiving device is connected to.

The receiving device X020 may be configured to, e.g. by means of the processing unit 1500 and/or the transmitting unit 1503 being configured to, transmit, to the end station, the broadcasted time information relating to the time domain supported by the end station of the TSN.

The receiving device X020 may be configured to, e.g. by means of the processing unit 1500 and/or the obtaining unit 1504 being configured to, obtain the information regarding the time domain supported by the end stations in the TSN by being configured to, e.g. by means of the processing unit 1500 and/or the receiving unit 1501 being configured to, receive a gPTP message, such as e.g. a gPTP Announce message. The gPTP message may be delivered periodically by the end station.

The receiving device X020 may be configured to, e.g. by means of the processing unit 1500 and/or the obtaining unit 1504 being configured to, obtain the information regarding the time domain supported by the end stations in the TSN, by receiving information from a TSN network controller, wherein the information comprises a receiving device identifier, such as e.g. a UE identifier, or a MAC address of an end station.

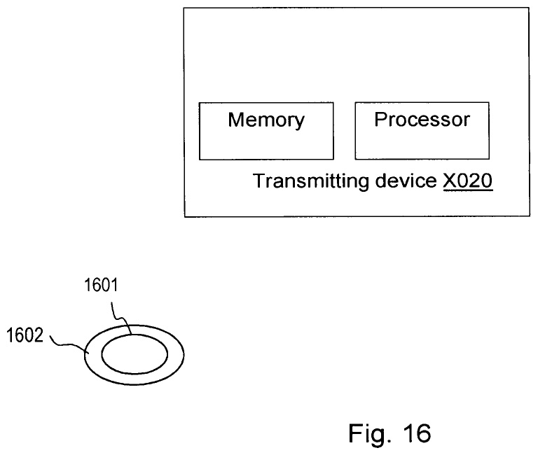

The embodiments herein may be implemented through a respective processor or one or more processors of a processing circuitry in the receiving device X020 as depicted in FIG. 16, which processing circuitry is configured to perform the method actions according to FIG. 12 and the embodiments described above for the receiving device X020.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the receiving device X020. One such carrier may be in the form of a CD ROM disc. It is however feasible with other data carriers such as e.g. a memory stick. The computer program code may furthermore be provided as pure program code on a server and downloaded to the receiving device X020.

The receiving device may further comprise a memory 1505. The memory may comprise one or more memory units to be used to store data on, such as e.g. information regarding the retransmissions, PUSCH resource table, software, patches, system information (SI), configurations, diagnostic data, performance data and/or applications to perform the methods disclosed herein when being executed, and similar.

The method according to the embodiments described herein for the receiving device X020 may be implemented by means of e.g. a computer program product 1506, 1601 or a computer program, comprising instructions, i.e., software code portions, which, when executed on at least one processor, cause at least one processor to carry out the actions described herein, as performed by the receiving device X020. The computer program product 1506, 1601 may be stored on a computer-readable storage medium 1507, 1602, e.g. a disc or similar. The computer-readable storage medium 1507, 1602, having stored thereon the computer program, may comprise instructions which, when executed on at least one processor, cause the at least one processor to carry out the actions described herein, as performed by the receiving device X020. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of the receiving device X020.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

### Further Extensions and Variations

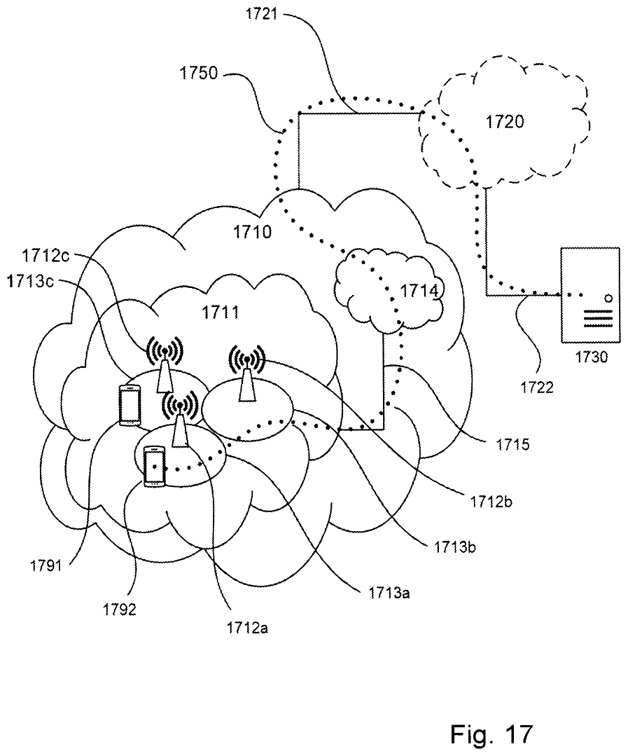

With reference to FIG. 17, in accordance with an embodiment, a communication system includes telecommunication network 1710, such as a 3GPP-type cellular network, which comprises access network 1711, such as a radio access network, and core network 1714. Access network 1711 comprises a plurality of base stations 1712a, 1712b, 1712c, e.g. the network node 110, such as NBs, eNBs, gNBs or other types of wireless access points, each defining a corresponding coverage area 1713a, 1713b, 1713c. Each base station 1712a, 1712b, 1712c is connectable to core network 1714 over a wired or wireless connection 1715. A first UE 1791, such as the UE 120, located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

Telecommunication network 1710 is itself connected to host computer 1730, which may be embodied in the hardware and/or software of a standalone server, a cloud-implemented server, a distributed server or as processing resources in a server farm. Host computer 1730 may be under the ownership or control of a service provider, or may be operated by the service provider or on behalf of the service provider. Connections 1721 and 1722 between telecommunication network 1710 and host computer 1730 may extend directly from core network 1714 to host computer 1730 or may go via an optional intermediate network 1720. Intermediate network 1720 may be one of, or a combination of more than one of, a public, private or hosted network; intermediate network 1720, if any, may be a backbone network or the Internet; in particular, intermediate network 1720 may comprise two or more sub-networks (not shown).

The communication system of FIG. 17 as a whole enables connectivity between the connected UEs 1791, 1792 and host computer 1730. The connectivity may be described as an over-the-top (OTT) connection 1750. Host computer 1730 and the connected UEs 1791, 1792 are configured to communicate data and/or signaling via OTT connection 1750, using access network 1711, core network 1714, any intermediate network 1720 and possible further infrastructure (not shown) as intermediaries. OTT connection 1750 may be transparent in the sense that the participating communication devices through which OTT connection 1750 passes are unaware of routing of uplink (UL) and downlink (DL) communications. For example, base station 1712 may not or need not be informed about the past routing of an incoming downlink communication with data originating from host computer 1730 to be forwarded (e.g., handed over) to a connected UE 1791. Similarly, base station 1712 need not be aware of the future routing of an outgoing uplink communication originating from the UE 1791 towards the host computer 1730.

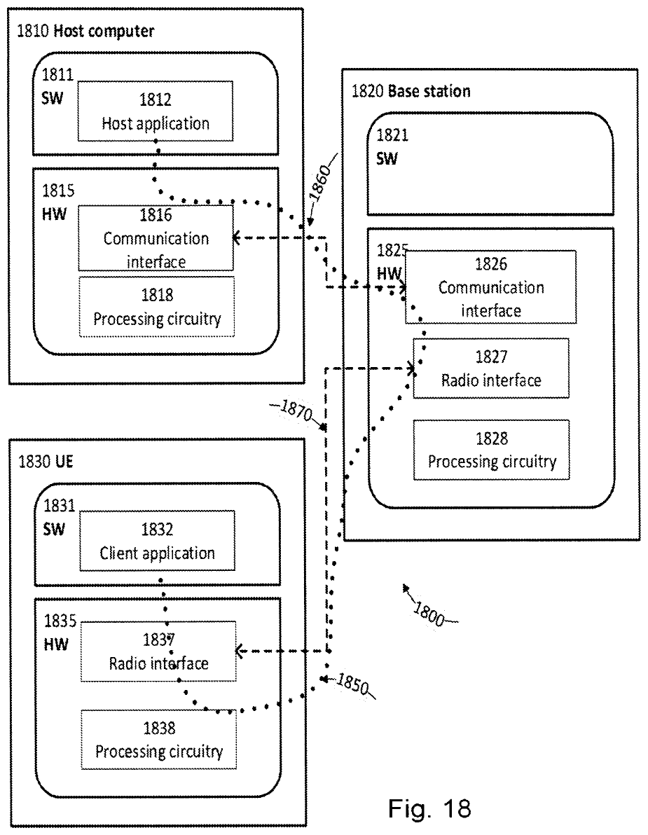

Example implementations, in accordance with an embodiment, of the UE, base station and host computer discussed in the preceding paragraphs will now be described with reference to FIG. 18. In communication system 1800, host computer 1810 comprises hardware 1815 including communication interface 1816 configured to set up and maintain a wired or wireless connection with an interface of a different communication device of communication system 1800. Host computer 1810 further comprises processing circuitry 1818, which may have storage and/or processing capabilities. In particular, processing circuitry 1818 may comprise one or more programmable processors, application-specific integrated circuits, field programmable gate arrays or combinations of these (not shown) adapted to execute instructions. Host computer 1810 further comprises software 1811, which is stored in or accessible by host computer 1810 and executable by processing circuitry 1818. Software 1811 includes host application 1812. Host application 1812 may be operable to provide a service to a remote user, such as UE 1830 connecting via OTT connection 1850 terminating at UE 1830 and host computer 1810. In providing the service to the remote user, host application 1812 may provide user data which is transmitted using OTT connection 1850.

Communication system 1800 further includes base station 1820 provided in a telecommunication system and comprising hardware 1825 enabling it to communicate with host computer 1810 and with UE 1830. Hardware 1825 may include communication interface 1826 for setting up and maintaining a wired or wireless connection with an interface of a different communication device of communication system 1800, as well as radio interface 1827 for setting up and maintaining at least wireless connection 1870 with UE 1830 located in a coverage area (not shown in FIG. 18) served by base station 1820. Communication interface 1826 may be configured to facilitate connection 1860 to host computer 1810. Connection 1860 may be direct or it may pass through a core network (not shown in FIG. 18) of the telecommunication system and/or through one or more intermediate networks outside the telecommunication system. In the embodiment shown, hardware 1825 of base station 1820 further includes processing circuitry 1828, which may comprise one or more programmable processors, application-specific integrated circuits, field programmable gate arrays or combinations of these (not shown) adapted to execute instructions. Base station 1820 further has software 1821 stored internally or accessible via an external connection.

Communication system 1800 further includes UE 1830 already referred to. Its hardware 1835 may include radio interface 1837 configured to set up and maintain wireless connection 1870 with a base station serving a coverage area in which UE 1830 is currently located. Hardware 1835 of UE 1830 further includes processing circuitry 1838, which may comprise one or more programmable processors, application-specific integrated circuits, field programmable gate arrays or combinations of these (not shown) adapted to execute instructions. UE 1830 further comprises software 1831, which is stored in or accessible by UE 1830 and executable by processing circuitry 1838. Software 1831 includes client application 1832. Client application 1832 may be operable to provide a service to a human or non-human user via UE 1830, with the support of host computer 1810. In host computer 1810, an executing host application 1812 may communicate with the executing client application 1832 via OTT connection 1850 terminating at UE 1830 and host computer 1810. In providing the service to the user, client application 1832 may receive request data from host application 1812 and provide user data in response to the request data. OTT connection 1850 may transfer both the request data and the user data. Client application 1832 may interact with the user to generate the user data that it provides.

It is noted that host computer 1810, base station 1820 and UE 1830 illustrated in FIG. 18 may be similar or identical to host computer 1730, one of base stations 1712a, 1712b, 1712c and one of UEs 1791, 1792 of FIG. 17, respectively. This is to say, the inner workings of these entities may be as shown in FIG. 18 and independently, the surrounding network topology may be that of FIG. 17.

In FIG. 18, OTT connection 1850 has been drawn abstractly to illustrate the communication between host computer 1810 and UE 1830 via base station 1820, without explicit reference to any intermediary devices and the precise routing of messages via these devices. Network infrastructure may determine the routing, which it may be configured to hide from UE 1830 or from the service provider operating host computer 1810, or both. While OTT connection 1850 is active, the network infrastructure may further take decisions by which it dynamically changes the routing (e.g., on the basis of load balancing consideration or reconfiguration of the network).

Wireless connection 1870 between UE 1830 and base station 1820 is in accordance with the teachings of the embodiments described throughout this disclosure. One or more of the various embodiments improve the performance of OTT services provided to UE 1830 using OTT connection 1850, in which wireless connection 1870 forms the last segment. More precisely, the teachings of these embodiments may improve the synchronization of PTP messages sent via the 5G network and thereby provide benefits such as improved performance of the communications network, in particular when performing mobility operations in a TSN.

A measurement procedure may be provided for the purpose of monitoring data rate, latency and other factors on which the one or more embodiments improve. There may further be an optional network functionality for reconfiguring OTT connection 1850 between host computer 1810 and UE 1830, in response to variations in the measurement results. The measurement procedure and/or the network functionality for reconfiguring OTT connection 1850 may be implemented in software 1811 and hardware 1815 of host computer 1810 or in software 1831 and hardware 1835 of UE 1830, or both. In embodiments, sensors (not shown) may be deployed in or in association with communication devices through which OTT connection 1850 passes; the sensors may participate in the measurement procedure by supplying values of the monitored quantities exemplified above, or supplying values of other physical quantities from which software 1811, 1831 may compute or estimate the monitored quantities. The reconfiguring of OTT connection 1850 may include message format, retransmission settings, preferred routing etc.; the reconfiguring need not affect base station 1820, and it may be unknown or imperceptible to base station 1820. Such procedures and functionalities may be known and practiced in the art. In certain embodiments, measurements may involve proprietary UE signaling facilitating host computer 1810's measurements of throughput, propagation times, latency and the like. The measurements may be implemented in that software 1811 and 1831 causes messages to be transmitted, in particular empty or ‘dummy’ messages, using OTT connection 1850 while it monitors propagation times, errors etc.

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In step 1910, the host computer provides user data. In substep 1911 (which may be optional) of step 1910, the host computer provides the user data by executing a host application. In step 1920, the host computer initiates a transmission carrying the user data to the UE. In step 1930 (which may be optional), the base station transmits to the UE the user data which was carried in the transmission that the host computer initiated, in accordance with the teachings of the embodiments described throughout this disclosure. In step 1940 (which may also be optional), the UE executes a client application associated with the host application executed by the host computer.

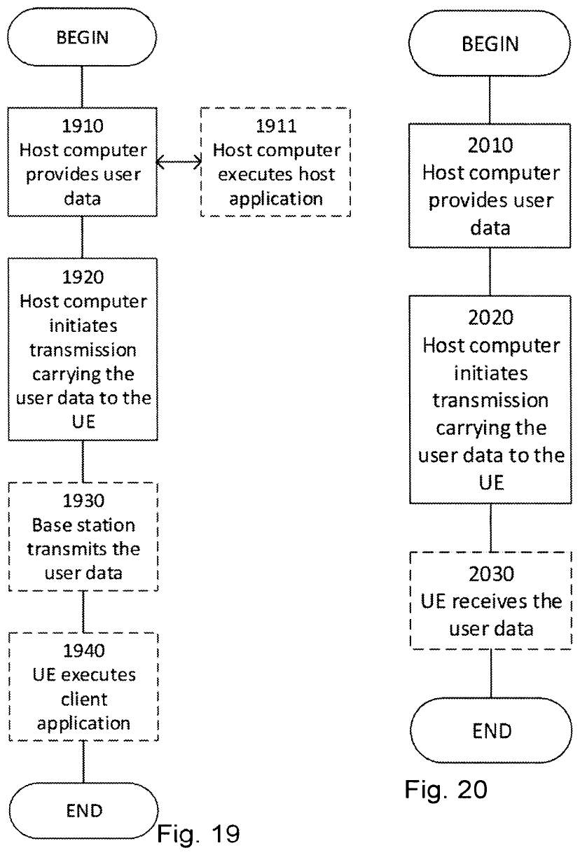

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In step 2010 of the method, the host computer provides user data. In an optional substep (not shown) the host computer provides the user data by executing a host application. In step 2020, the host computer initiates a transmission carrying the user data to the UE. The transmission may pass via the base station, in accordance with the teachings of the embodiments described throughout this disclosure. In step 2030 (which may be optional), the UE receives the user data carried in the transmission.

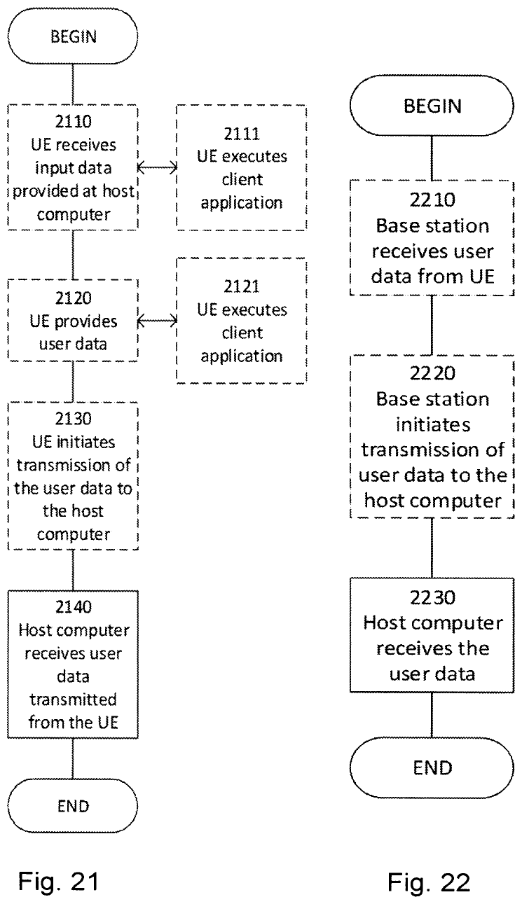

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In step 2110 (which may be optional), the UE receives input data provided by the host computer. Additionally or alternatively, in step 2120, the UE provides user data. In substep 2121 (which may be optional) of step 2120, the UE provides the user data by executing a client application. In substep 2111 (which may be optional) of step 2110, the UE executes a client application which provides the user data in reaction to the received input data provided by the host computer. In providing the user data, the executed client application may further consider user input received from the user. Regardless of the specific manner in which the user data was provided, the UE initiates, in substep 2130 (which may be optional), transmission of the user data to the host computer. In step 2140 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In step 2210 (which may be optional), in accordance with the teachings of the embodiments described throughout this disclosure, the base station receives user data from the UE. In step 2220 (which may be optional), the base station initiates transmission of the received user data to the host computer. In step 2230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Below, some example embodiments 1-20 are described.

Embodiment 1. A method, performed by a transmitting device, such as e.g. a UE (120), a radio network node (110) and/or a User Plane Function (UPF), in a wireless communication system (100), such as e.g. a 5G system, for handling generalized Precise Timing Protocol, gPTP, signaling, from a Time Sensitive Network, TSN, the method comprising:
receiving 1101, from a TSN network, a gPTP message, wherein the gPTP message comprises time information and a time domain related to the time information,
extracting 1102 the time information and the time domain from the gPTP message,
transmitting 1103, to a receiving device, such as e.g. the radio network node (110), the UPF and/or the UE (120), a 3GPP message comprising the time information and the time domain related to the time information.
   Embodiment 2. The method according to Embodiment 1, wherein the 3GPP message is transmitted to the receiving device using multicast or unicast, wherein the method further comprises:
obtaining 1103, information regarding the time domain to which the receiving device is related,
transmitting 1104a the 3GPP message comprising the time information and the time domain related to the time information to one or more receiving devices related to the time domain comprised in the 3GPP message.
   Embodiment 3. The method according to Embodiment 1, wherein the transmitting device is a radio network node or a UPF, and the 3GPP message is transmitted using broadcasting, wherein the method further comprises:
transmitting 1104b, to the receiving device, an additional parameter or a dedicated signaling in the 3GPP message, which additional parameter indicates the time domain or a time domain number which the broadcasted 3GPP message relates to.
   Embodiment 4. The method according to Embodiment 2, wherein the information regarding the time domain to which a specific device is related is obtained by receiving a signal from the receiving device about which time domain the receiving device is related to, e.g. by means of RRC signaling.
   Embodiment 5. The method according to Embodiment 2, wherein the receiving device is preconfigured with one or more specific time domains and wherein the information regarding the time domain to which the receiving device is related is obtained by querying a database comprising the time domains that the specific receiving device is configured to support, and wherein the time domain comprised in the 3GPP message is indicated using an identifier.
   Embodiment 6. A method, performed by a receiving device such as e.g. a UE (120), a radio network node (110) and/or a User Plane Function (UPF), in a 3GPP wireless communication system (100), such as e.g. a 5G system, for handling generalized Precise Timing Protocol, gPTP, signaling, from a Time Sensitive Network, TSN, the method comprising:
receiving 1201, from a transmitting device, such as e.g. the radio network node (110), the UPF and/or the UE (120), a 3GPP message comprising a time information and a time domain related to the time information.
re-creating 1202, based on the time information and the time domain comprised in the 3GPP message, a gPTP message comprising the time information and the time domain related to the time information,
transmitting 1204, to one or more end stations in the TSN network, a gPTP message, wherein the gPTP message comprises the time information and the time domain related to the time information extracted from the 3GPP message.
   Embodiment 7. The method according to Embodiment 6, wherein when the 3GPP message is received as a broadcasted message, the method further comprises:
obtaining 1203 information regarding time domain supported by the one or more end stations in the TSN network, which end stations the receiving device is connected to, and
transmitting 1204a, to the end station, the broadcasted time information relating to the time domain supported by the end station of the TSN.
   Embodiment 8. The method according to embodiment 6 or 7, wherein the information regarding the time domain supported by the end stations in the TSN, is obtained by receiving a gPTP message, such as e.g. a gPTP Announce message, delivered periodically by the end station.
   Embodiment 9. The method according to embodiment 6 or 7, wherein the information regarding the time domain supported by the end stations in the TSN, is obtained by receiving information from a TSN network controller, wherein the information comprises a receiving device identifier, such as e.g. a UE identifier, or a MAC address of an end station.
   Embodiment 10. A transmitting device, such as e.g. a UE (120), a radio network node (110) and/or a User Plane Function (UPF), in a 3GPP wireless communication system (100), such as e.g. a 5G system, for handling generalized Precise Timing Protocol, gPTP, signaling, from a Time Sensitive Network, TSN, the transmitting device being configured to:
receive, from a TSN network, a gPTP message, wherein the gPTP message comprises time information and a time domain related to the time information,
extract the time information and the time domain from the gPTP message,
transmit, to a receiving device, such as e.g. the radio network node (110), the UPF and/or the UE (120), a 3GPP message comprising the time information and the time domain related to the time information,
   In some embodiments also:
Perform an ingress timestamp using the clock that serves as the time reference to indicate when the gPTP message is received from the TSN network and include the ingress timestamp as part of the time information
   Embodiment 11. The transmitting device according to Embodiment 10, wherein the transmitting device is configured to transmit the 3GPP message is transmitted to the receiving device using multicast or unicast, wherein the transmitting device is further configured to:
obtain information regarding the time domain to which the receiving device is related,
transmit the 3GPP message comprising the time information and the time domain related to the time information to one or more receiving devices related to the time domain comprised in the 3GPP message.
   Embodiment 12. The transmitting device according to Embodiment 11, wherein the transmitting device is a radio network node or a UPF, and the 3GPP message is transmitted using broadcasting, wherein the transmitting device is further configured to:
transmit to the receiving device, an additional parameter or a dedicated signaling in the 3GPP message, which additional parameter indicates the time domain or a time domain number which the broadcasted 3GPP message relates to.
   Embodiment 13. The transmitting device according to Embodiment 11, wherein the information regarding the time domain to which a specific device is related is obtained by receiving a signal from the receiving device about the time domain which the receiving device is related to, e.g. by means of RRC signaling.
   Embodiment 14. The transmitting device according to Embodiment 11, wherein the receiving device is preconfigured with one or more specific time domains and wherein the transmitting device is configured to obtain the information regarding the time domain to which the receiving device is related is by querying a database comprising the time domains that the specific receiving device is configured to support, and wherein the time domain comprised in the 3GPP message is indicated using an identifier.
   Embodiment 15. A receiving device, such as e.g. a UE (120), a radio network node (110) and/or a User Plane Function (UPF), in a wireless communication system (100), such as e.g. a 5G system, for handling generalized Precise Timing Protocol, gPTP, signaling, from a Time Sensitive Network, TSN, the receiving device being configured to:
receive, from a transmitting device, such as e.g. the radio network node (110), the UPF and/or the UE (120), a 3GPP message comprising a time information and a time domain related to the time information.
re-create, based on the time information and the time domain comprised in the 3GPP message and e.g. the delay experienced in sending the 3GPP message from the transmitting device to the receiving device, a gPTP message comprising the time information and the time domain related to the time information,
transmit, to one or more end stations in the TSN network e.g. connected to the receiving device, the gPTP message, wherein the gPTP message comprises the time information and the time domain related to the time information extracted from the 3GPP message and e.g. the delay experienced in sending the 3GPP message from the transmitting device to the receiving device.
   Embodiment 16. The receiving device according to Embodiment 15, wherein when the 3GPP message is received as a broadcasted message, the receiving device further being configured to:
obtain information regarding a time domain supported by the one or more end stations in the TSN network, which end stations the receiving device is connected to, and
transmit, to the end station, e.g. the re-created gPTP message or the broadcasted time information relating to the time domain supported by the end station of the TSN.
   Embodiment 17. The receiving device according to embodiment 15 or 16, wherein the information regarding the time domain supported by the end stations in the TSN, is obtained by receiving a gPTP message, such as e.g. a gPTP Announce message, delivered periodically by the end station.
   Embodiment 18. The receiving device according to embodiment 15 or 16, wherein the information regarding the time domain supported by the end stations in the TSN, is obtained by receiving information from a TSN network controller, wherein the information comprises a receiving device identifier, such as e.g. a UE identifier, or a MAC address of an end station.
   Embodiment 19. A computer program comprising instructions, which when executed by a processor, causes the processor to perform actions according to any of the Embodiments 1-9.
   Embodiment 20. A carrier comprising the computer program of Embodiment 19, wherein the carrier is one of an electronic signal, an optical signal, an electromagnetic signal, a magnetic signal, an electric signal, a radio signal, a microwave signal, or a computer-readable storage medium.

1-32. (canceled)

33. A method performed by a transmitting device in a wireless communication system, for handling generalized Precise Timing Protocol (gPTP) signaling from a Time Sensitive Network (TSN), the method comprising:
receiving a gPTP message from the TSN, wherein the gPTP message comprises time information and a time domain related to the time information;
extracting the time information and the time domain from the gPTP message; and
transmitting to a receiving device a Third Generation Partnership Project (3GPP) message comprising the time information and the time domain related to the time information.

34. The method according to claim 33, wherein the transmitting device is a radio network node or a User Plane Function (UPF), and the 3GPP message is transmitted using broadcasting, and wherein the method further comprises:
transmitting to the receiving device an additional parameter that indicates the time domain or a time domain number to which the broadcasted 3GPP message relates.

35. A method performed by a receiving device in a Third Generation Partnership Project (3GPP) wireless communication system, for handling generalized Precise Timing Protocol (gPTP) signaling from a Time Sensitive Network (TSN), the method comprising:
receiving, from a transmitting device, a 3GPP message comprising time information and a time domain related to the time information;
re-creating based on the time information and the time domain comprised in the 3GPP message, a gPTP message comprising the time information and the time domain related to the time information; and
transmitting the gPTP message to one or more end stations in the TSN.

36. The method according to claim 35, wherein when the 3GPP message is received as a broadcasted message, and wherein the method further comprises:
obtaining information regarding time domains supported by the one or more end stations in the TSN; and
transmitting, to each end station, the broadcasted time information relating to the time domain supported by the end station.

37. The method according to claim 35, wherein the information regarding the time domain supported by the one or more end stations in the TSN, is obtained by receiving a gPTP message, delivered periodically by each of the one or more end stations.

38. The method according to claim 37, wherein the gPTP message is represented by an announce message.

39. The method according to claim 35, wherein the information regarding the time domain supported by the one or more end stations is obtained by receiving information from a TSN network controller, wherein the information comprises one or more receiving device identifiers.

40. A transmitting device in a Third Generation Partnership Project (3GPP) wireless communication system, for handling generalized Precise Timing Protocol (gPTP) signaling from a Time Sensitive Network (TSN), the transmitting device being configured to:
receive a gPTP message from the TSN, wherein the gPTP message comprises time information and a time domain related to the time information;
extract the time information and the time domain from the gPTP message;
transmit to a receiving device, a 3GPP message comprising the time information and the time domain related to the time information.

41. The transmitting device according to claim 40, wherein the transmitting device is a radio network node or a User Plane Function (UPF) and the 3GPP message is transmitted using broadcasting, wherein the transmitting device is further configured to.
transmit to the receiving device, an additional parameter that indicates the time domain or a time domain number to which the broadcasted 3GPP message.

42. A receiving device in a wireless communication system, for handling generalized Precise Timing Protocol (gPTP) signaling, from a Time Sensitive Network (TSN), the receiving device being configured to:
receive, from a transmitting device, a Third Generation Partnership Project (3GPP) message comprising time information and a time domain related to the time information;
create a gPTP message comprising the time information and the time domain related to the time information; and
transmit the gPTP message to one or more end stations in the TSN.

43. The receiving device according to claim 42, wherein when the 3GPP message is received as a broadcasted message, the receiving device further being configured to:
obtain information regarding time domains supported by the one or more end stations in the TSN network; and
transmit to each end station the broadcasted time information relating to the time domain supported by the end station.

44. The receiving device according to claim 42, wherein the information regarding the time domain supported by the end stations is obtained by receiving a gPTP message, delivered periodically by each end station.

45. The receiving device according to claims 44, wherein the gPTP message is represented by an announce message.

46. The receiving device according to claim 42, wherein the information regarding the time domains supported by the one or more end stations is obtained by receiving information from a TSN network controller, wherein the information comprises one or more receiving device identifiers.
